(19) United States
(12) Patent Application Publication
(10) Pub. No.: US 2016/0215085 A1
(43) Pub. Date: Jul. 28, 2016

(54) Methods of Purifying a Block Copolymer and Methods of Forming a Pattern Using the Block Copolymer

(71) Applicant: Samsung Electronics Co., Ltd., Suwon-si (KR)

(72) Inventors: Junwon HAN, Seoul (KR); Su-Jin KWON, Hwaseong-si (KR); Seungwon KIM, Hwaseong-si (KR); Hyunwoo KIM, Seongnam-si (KR); Jungsik CHOI, Seongnam-si (KR)

(21) Appl. No.: 14/981,194

(22) Filed: Dec. 28, 2015

(30) Foreign Application Priority Data
Jan. 23, 2015 (KR) 10-2015-0011324

(51) Int. Cl. C08F 293/00; C08L 53/00

(52) U.S. Cl. CPC C08F 293/00; C08L 53/00; C08L 2205/025

(57) ABSTRACT

The inventive concepts provide methods of purifying a block copolymer and methods of forming a pattern using the same. The purifying method is performed using a first adsorbent. The first adsorbent has adsorbability with respect to a first polymer block having a molecular weight equal to or greater than a first average molecular weight. The purifying method further includes purifying a synthesized polymer using a second adsorbent. The second adsorbent interacts with a second polymer block.

### CROSS-REFERENCE TO RELATED APPLICATION

This application claims priority under 35 U.S.C. §119 to Korean Patent Application No. 10-2015-0011324, filed on Jan. 23, 2015, in the Korean Intellectual Property Office, the disclosure of which is hereby incorporated by reference in its entirety.

### BACKGROUND

The inventive concepts relate to methods of forming a pattern. More particularly, the inventive concepts relate to methods of purifying a block copolymer and methods of forming a pattern using the block copolymer.

Fine patterns should be needed to manufacture highly integrated semiconductor devices. To integrate a lot of elements in a small area, a size of an individual element should be as small as possible. In addition, a pitch including a width of each of patterns constituting the individual element and a space between the patterns should be as small as possible. As design rules of semiconductor devices have been rapidly reduced, it may be difficult to form patterns having a fine pitch by a resolution limitation of a photolithography process used to form the patterns. Thus, it may be required to develop a direct self-assembly (DSA) method induced using a block copolymer.

### SUMMARY

Embodiments of the inventive concepts may provide methods of purifying a block copolymer capable of improving purity thereof.

Embodiments of the inventive concepts may also provide methods of separating a block copolymer capable of easily manufacturing various block copolymers.

Embodiments of the inventive concepts may also provide methods of forming a pattern using the block copolymer.

In an embodiment, the purifying method may include providing a block copolymer including a first polymer block and a second polymer block, the block copolymer formed by polymerizing a first monomer and a second monomer, forming a first mixture solution by dissolving the block copolymer and a first adsorbent in a first solvent, the first adsorbent having adsorbability with respect to the first polymer block having a first molecular weight or more in the first solvent, forming a first complex by adsorbing the block copolymer on the first adsorbent, and separating the first complex from the first mixture solution.

In another embodiment, the purifying method may further include forming a second mixture solution by dissolving the block copolymer and a second adsorbent in a second solvent, the second adsorbent interacting with the second polymer block in the second solvent, forming a second complex by adsorbing the block copolymer on the second adsorbent, and separating the second complex from the second solvent.

In another embodiment, the block copolymer may include a first block copolymer, a second block copolymer, and a third block copolymer. The first polymer block of the first block copolymer may have a molecular weight equal to the first molecular weight, the first polymer block of the second block copolymer may have a molecular weight greater than the first molecular weight, and the first polymer block of the third block copolymer may have a molecular weight smaller than the first molecular weight.

In another embodiment, the second complex may include the first block copolymer adsorbed on the second adsorbent, and the second block copolymer may not be adsorbed on the second adsorbent.

In another embodiment, providing the block copolymer may further include providing a first homopolymer formed by polymerization of the first monomer, the first homopolymer including the same polymer as the first polymer block, and providing a second homopolymer formed by polymerization of the second monomer, the second homopolymer including the same polymer as the second polymer block.

In another embodiment, the first complex may further include the first homopolymer adsorbed on the first adsorbent. The second homopolymer may not be adsorbed on the first adsorbent.

In another embodiment, the first homopolymer may not be adsorbed on the second adsorbent in the second solvent.

In another embodiment, the second solvent may include a main solvent in which a first polymer has a high solubility and in which the main solvent has a volume ratio of 50 vol % to 70 vol %, and a co-solvent in which the first polymer has a low solubility and in which the co-solvent has a volume ratio of 30 vol % to 50 vol %. In some embodiments the first polymer can be, or comprises, a hydrophilic polymer, or predominantly comprises a hydrophilic polymer. In yet other embodiments, the first polymer can be a block copolymer that comprises a hydrophilic polymer block, or can be a block copolymer that predominantly comprises a hydrophilic polymer block. In still other embodiments, the hydrophilic polymer or hydrophilic polymer block may be, e.g., polymethyl methacrylate (PMMA), polydimethylsiloxane (PDMS), polyvinylpyrrolidone (PVP), or polyethylene oxide (PEO).

In another embodiment, the first polymer block may include a hydrophobic polymer, and the first adsorbent may include a silica particle coated with an alkyl chain.

In another embodiment, the first solvent may include a main solvent in which a second polymer has a high solubility and in which the main solvent has a volume ratio of about 50 vol % to about 70 vol %, and a co-solvent having in which the second polymer has a low solubility and in which the co-solvent has a volume ratio of 30 vol % to 50 vol %. In some embodiments the second polymer can be, or comprises, a hydrophobic polymer, or predominantly comprises a hydrophobic polymer. In yet other embodiments, the second polymer can be a block copolymer that comprises a hydrophobic polymer block, or can be a block copolymer that predominantly comprises a hydrophobic polymer block. In yet other embodiments, the hydrophobic polymer or hydrophobic polymer block may be, e.g., polystyrene (PS).

In another embodiment, the main solvent may include methylene chloride, and the co-solvent may include acetonitrile.

In another embodiment, the purifying method may further include forming a first block copolymer composition by filtering and precipitating the first mixture solution from which the first complex is separated. A composition ratio of the first block copolymer composition may be different from that of the block copolymer.

In another embodiment, the purifying method may further include adding the first complex into a solvent having high solubility to desorb the block copolymer from the first adsorbent.

In yet another embodiment, the purifying method may include polymerizing a first monomer and a second monomer to form a block copolymer, the block copolymer including a hydrophobic polymer block and a hydrophilic polymer block, forming a first mixture solution by dissolving the block copolymer and a hydrophobic adsorbent n a first solvent, forming a first complex by adsorbing the block copolymer on the hydrophobic adsorbent, the hydrophobic adsorbent having adsorbability with respect to the hydrophobic polymer block having a first molecular weight or more in the first solvent, and separating the first complex from the first solvent. Polymerizing the first monomer and the second monomer may include forming a first homopolymer and a second homopolymer. The first homopolymer may include the same polymer as the hydrophobic polymer block, and the second homopolymer may include the same polymer as the hydrophilic polymer block. The block copolymer may include a first block copolymer, a second block copolymer, and a third block copolymer. The hydrophobic polymer block of the first block copolymer may have a molecular weight equal to the first molecular weight, the hydrophobic polymer block of the second block copolymer may have a molecular weight greater than the first molecular weight, and the hydrophobic polymer block of the third block copolymer may have a molecular weight smaller than the first molecular weight.

In yet another embodiment, the purifying method may further include forming a second mixture solution by dissolving the block copolymer and a hydrophilic adsorbent in a second solvent, the hydrophilic adsorbent interacting with the hydrophilic polymer block in the second solvent, forming a second complex by adsorbing the block copolymer on the hydrophilic adsorbent, and separating the second complex from the second solvent.

In yet another embodiment, the purifying method may further include forming a second block copolymer composition by filtering and precipitating the second mixture solution from which the second complex is separated. A composition ratio of the second block copolymer composition may be different from that of the block copolymer.

In yet another embodiment, the purifying method may further include forming a first block copolymer composition by filtering and precipitating the first mixture solution from which the first complex is separated. A composition ratio of the first block copolymer composition may be different from that of the block copolymer.

In yet another embodiment, the first complex may include the hydrophobic adsorbent, the first block copolymer, the second block copolymer, and the first homopolymer. The third block copolymer and the second homopolymer may not be adsorbed on the hydrophobic adsorbent.

In yet another embodiment, the hydrophobic adsorbent may include a silica particle coated with an alkyl chain.

In still another embodiment, the method of forming a pattern may include forming a lower layer on a substrate, providing a block copolymer including a hydrophobic polymer block and a hydrophilic polymer block, forming a mixture solution by dissolving the block copolymer and a hydrophobic adsorbent in a solvent, the hydrophobic adsorbent having adsorbability with respect to the hydrophobic polymer block having a first molecular weight or more in the solvent, forming a complex by adsorbing the block copolymer on the hydrophobic adsorbent, separating the complex from the solvent, desorbing the block copolymer from the complex, depositing the desorbed block copolymer on the lower layer to form a block copolymer layer, thermally treating the block copolymer layer to form a first block portion and a second block portion, removing the second block portion to form a guide opening exposing the lower layer, and etching the lower layer exposed through the guide opening.

In still other embodiments, provided is a memory system and/or a semiconductor device comprising patterns, formed by methods according to the present inventive concept.

### BRIEF DESCRIPTION OF THE DRAWINGS

The inventive concepts will become more apparent in view of the attached drawings and accompanying detailed description.

FIG. 1 is a graph illustrating a polymer product depending on a composition ratio according to example embodiments of the inventive concepts.

FIGS. 2A to 2E are schematic diagrams illustrating a first method of purifying a block copolymer according to example embodiments of the inventive concepts.

FIGS. 3A to 3E are schematic diagrams illustrating a second method of purifying a block copolymer according to example embodiments of the inventive concepts.

FIGS. 4A to 4F are cross-sectional views illustrating a method of forming a pattern according to example embodiments of the inventive concepts.

FIG. 5 illustrates shape changes of a first block portion and a second block portion during phase change of a block copolymer according to example embodiments of the inventive concepts.

FIGS. 6A and 6B are graphs illustrating ultraviolet (UV) detection results of a comparison example 3-1 and an experimental example 3-1, respectively.

FIGS. 7A, 7B, and 7C are graphs illustrating UV detection results of a comparison example 4-1, a comparison example 4-2, and an experimental example 4-1, respectively.

### DETAILED DESCRIPTION OF THE EMBODIMENTS

The inventive concepts will now be described more fully hereinafter with reference to the accompanying drawings, in which exemplary embodiments of the inventive concepts are shown. The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts. In the drawings, embodiments of the inventive concepts are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concepts. Accordingly, shapes of the exemplary views may be modified according to manufacturing techniques and/or allowable errors. Therefore, the embodiments of the inventive concepts are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concepts.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concepts explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

As appreciated by the present inventive entity, devices and methods of forming devices according to various embodiments described herein may be embodied in microelectronic devices such as integrated circuits, wherein a plurality of devices according to various embodiments described herein are integrated in the same microelectronic device. Accordingly, the cross-sectional view(s) illustrated herein may be replicated in two different directions, which need not be orthogonal, in the microelectronic device. Thus, a plan view of the microelectronic device that embodies devices according to various embodiments described herein may include a plurality of the devices in an array and/or in a two-dimensional pattern that is based on the functionality of the microelectronic device.

The devices according to various embodiments described herein may be interspersed among other devices depending on the functionality of the microelectronic device. Moreover, microelectronic devices according to various embodiments described herein may be replicated in a third direction that may be orthogonal to the two different directions, to provide three-dimensional integrated circuits.

Accordingly, the cross-sectional view(s) illustrated herein provide support for a plurality of devices according to various embodiments described herein that extend along two different directions in a plan view and/or in three different directions in a perspective view. For example, when a single active region is illustrated in a cross-sectional view of a device/structure, the device/structure may include a plurality of active regions and transistor structures (or memory cell structures, gate structures, etc., as appropriate to the case) thereon, as would be illustrated by a plan view of the device/structure.

A method of forming a block copolymer according to embodiments of the inventive concepts will be described.

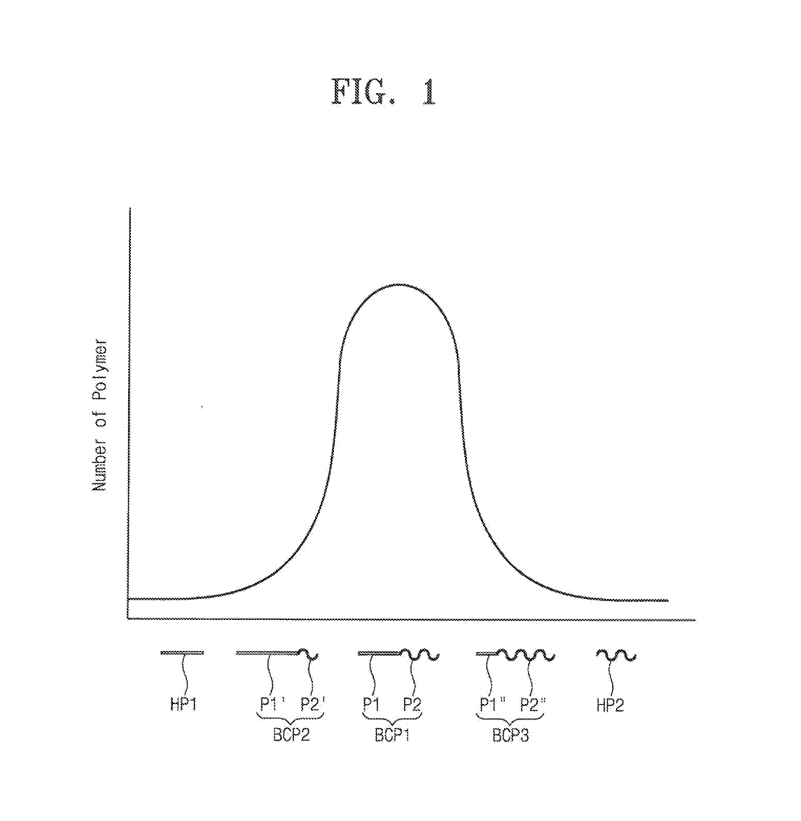

FIG. 1 is a graph illustrating polymer products formed depending on the composition ratio according to example embodiments of the inventive concepts. In FIG. 1, the horizontal axis represents polymers included in the polymer product and a vertical axis represents the relative amount of polymer products formed in, for example, a polymerization process. The polymer products may include a block copolymer and a homopolymer.

Referring to FIG. 1, a first monomer and a second monomer may be polymerized together in a polymerization process, and thus, forming polymers including, for example block copolymers BCP1, BCP2, and BCP3 as polymerization products. Synthesis of the block copolymer may be performed by any method that would be appreciated by one of skill in the art, for example, but not limited to, by a radical synthesis method. The first monomer may have hydrophilic properties and may be more hydrophilic, for example, may be more polar, as compared with the second monomer. For example, the first monomer may include at least one of methyl methacrylate (MMA), dimethylsiloxane (DMS), vinylpyrrolidone, or ethylene oxide. The second monomer may include styrene.

The block copolymer may be defined as a polymer including at least two polymer blocks of which ends are connected to each other by a covalent bond. For example, each of the block copolymer BCP1, BCP2, and BCP3 may include a first polymer block P1, P1′, and P1″, and a second polymer block P2, P2′, and P2″, respectively. The second polymer block P2, P2′, and P2″ may have a different property from the first polymer block P1, P1′, and P1″. For example, the first polymer block P1, P1′, and P1″ may include a hydrophilic polymer, e.g., polymethyl methacrylate (PMMA), polydimethylsiloxane (PDMS), polyvinylpyrrolidone (PVP), or polyethylene oxide (PEO). The second polymer block P2, P2′, and P2″ may include a hydrophobic polymer, e.g., polystyrene (PS).

The polymer product may include impurities formed by the polymerization process. For example, a first homopolymer HP1 and a second homopolymer HP2 may be formed in the polymerization process. The first homopolymer HP1 may be synthesized by polymerization of the first monomers, and the second homopolymer HP2 may be synthesized by polymerization of the second monomers. The first homopolymer HP1 may have hydrophilic properties, and the second homopolymer HP2 may have hydrophobic properties. For example, the first homopolymer HP1 may include the same polymer as the first polymer block P1, P1′, and P1″, and the second homopolymer HP2 may include the same polymer as the second polymer block P2, P2′, and P2″. As the amount of the first homopolymer HP1 and the amount of the second homopolymer HP2 increase in the polymerization, the content ratio of the block copolymer BCP1, BCP2 or BCP3 may be reduced in the polymerization products.

The polymerization products may include first, second, and third block copolymers BCP1, BCP2, and BCP3. The first to third block copolymers BCP1, BCP2, and BCP3 may include the first polymer blocks P1, P1′, and P1″, respectively, each having sizes or fractions in block copolymers BCP1, BCP2, and BCP3 that are different from one other. For example, in some embodiments, the size or fraction of the first polymer block P1 in the first block copolymer BCP1 may be smaller than that of the first polymer block P1′ in the second block copolymer BCP2 and greater than that of the first polymer block P1″ in the third block copolymer BCP3. In this example, the first to third block copolymers BCP1, BCP2, and BCP3 may have the same or about the same molecular weight or may have similar molecular weights to each other. The size or fraction of the second polymer block P2 in the first block copolymer BCP1 may be greater than that of the second polymer block P2′ in the second block copolymer BCP2 and smaller than that of the second polymer block P2″ in the third block copolymer BCP3. The size or the fraction of the first polymer block P1 may correspond to a molecular weight of the first polymer block P1 in a block copolymer. The first block copolymer BCP1 may include the first polymer block P1 having a first molecular weight. The second block copolymer BCP2 may include the first polymer block P1′ having a second molecular weight that is greater than the first molecular weight of the first polymer block P1 in the first block copolymer BCP1. The third block copolymer BCP3 may include the first polymer block P1″ having a third molecular weight smaller than the first molecular weight of the first polymer block P1 in the first block copolymer BCP1. The first block copolymer BCP1 may be the main product of the polymer product. Each of the second and third block copolymers BCP2 and BCP3 may be a minor product or an impurity in the forming of the polymers. As content ratios of the second and third block copolymers BCP2 and BCP3 increase in the polymer product, the content ratio of the first block copolymer BCP1 may decrease. Alternatively, the polymerization method and polymerization conditions for forming the polymers may be controlled, so the second block copolymer BCP2 or the third block copolymer BCP3 may become the main product in the polymer product.

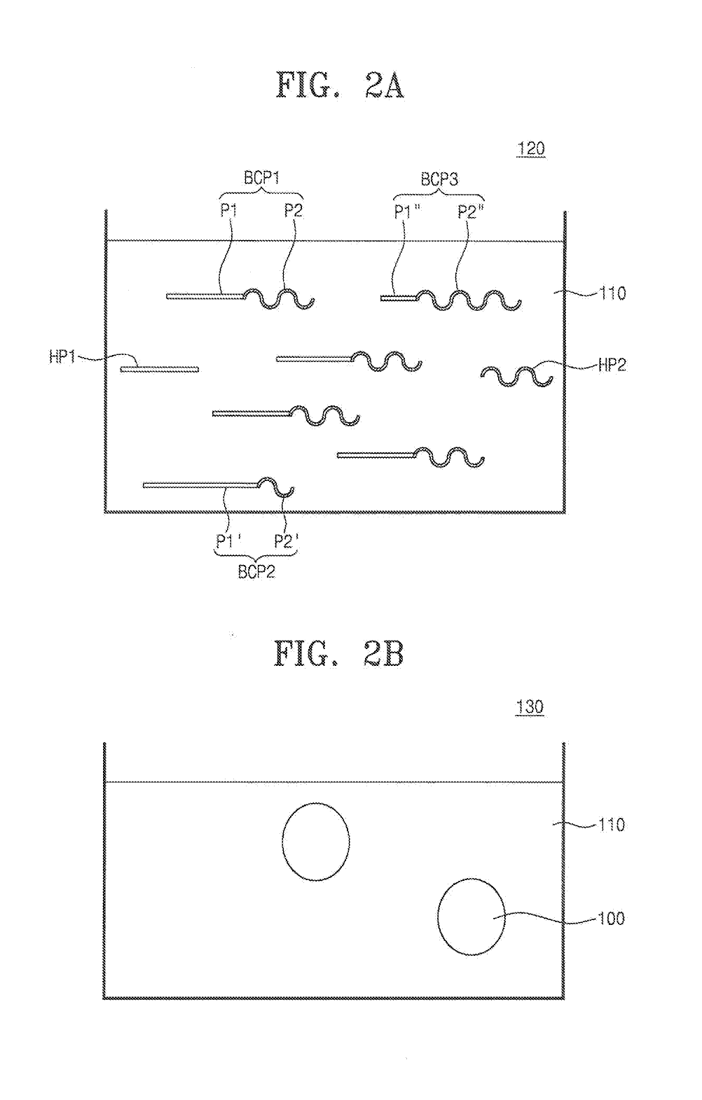

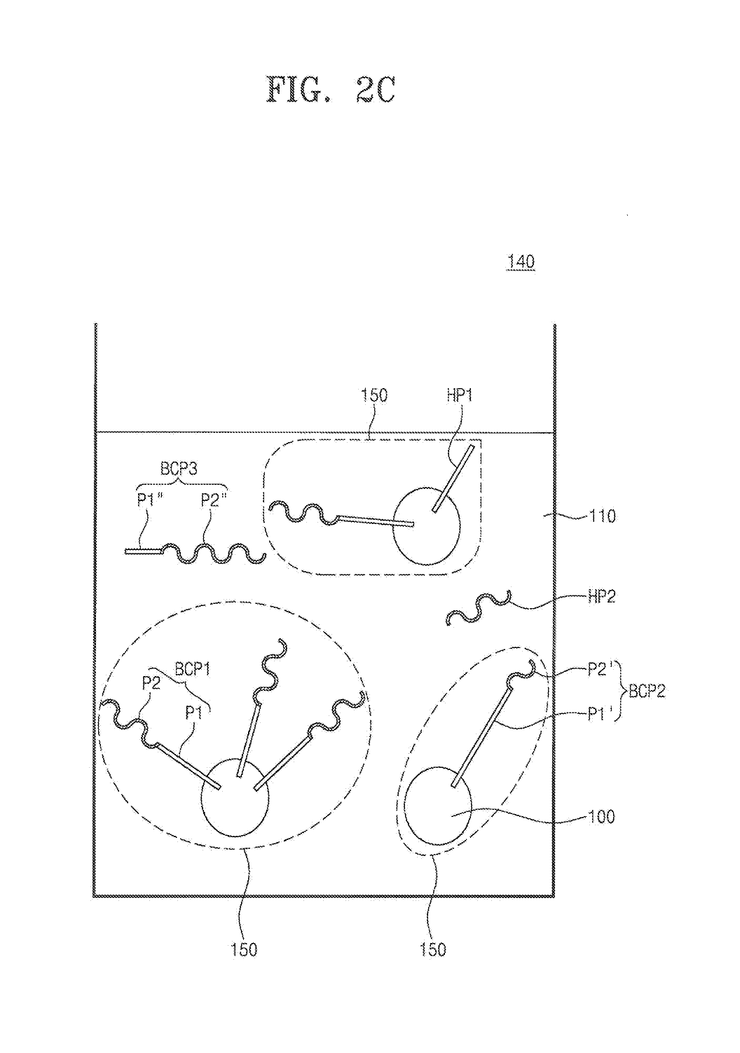

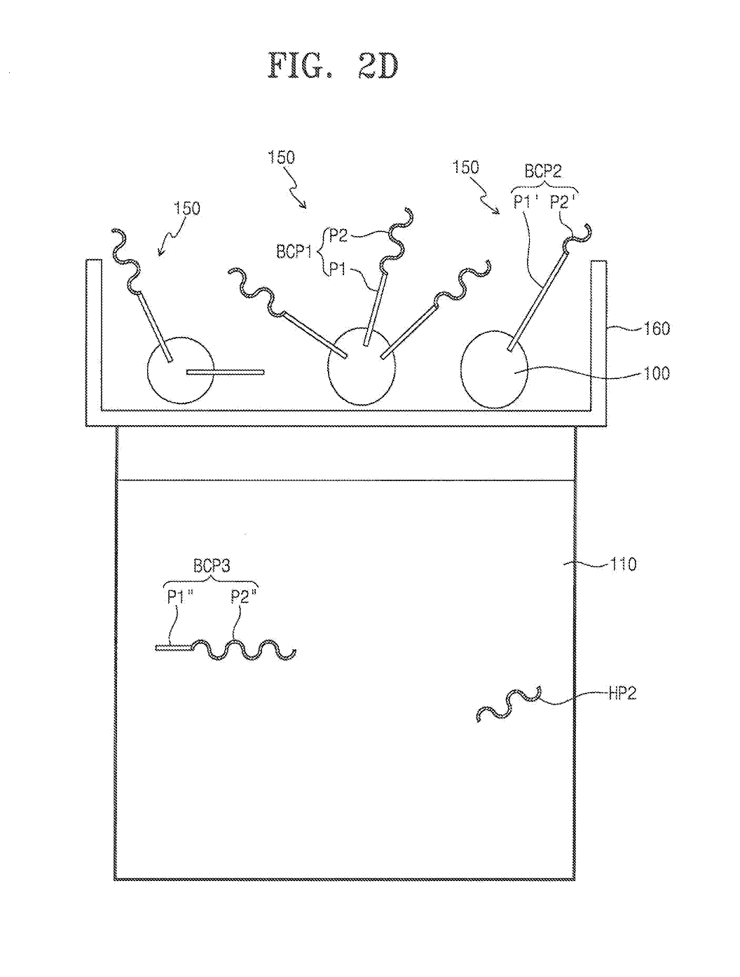

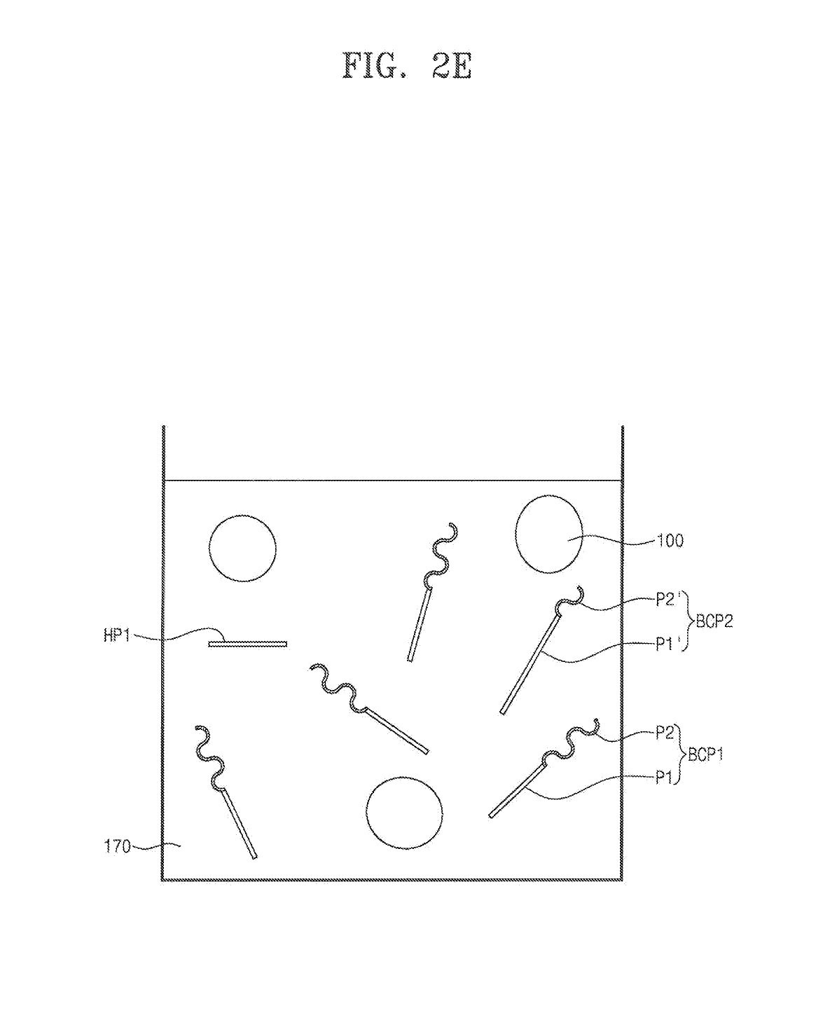

FIGS. 2A to 2E are schematic diagrams illustrating a first method of purifying a block copolymer according to example embodiments of the inventive concepts.

Referring to FIG. 2A, a polymer product may be added into a first solvent 110 to form a first polymer solution 120. Here, the polymer product may be formed as described with reference to FIG. 1, so the polymer product may include the first block copolymer BCP1, the second block copolymer BCP2, the third block copolymer BCP3, the first homopolymer HP1, and the second homopolymer HP2. The first solvent 110 may include a main solvent and a co-solvent. The main solvent may include at least one of solvents having high solubility with respect to a polymer. For example, the main solvent may include at least one of tetrahydrofuran (THF), triethylamine (TEA), dimethylformamide (DMF), ethyl acetate, or dimethyl sulfoxide (DMSO). The co-solvent may include isooctane. A solubility of the co-solvent with respect to the polymer may be lower than that of the main solvent with respect to the polymer. Volume ratios of the main solvent and the co-solvent may be adjusted, so the first solvent 110 may include the main solvent of about 50 vol % to about 70 vol %. If the volume ratio of the main solvent in the first solvent 110 is lower than 50 vol %, the homopolymers HP1 and HP2 and the block copolymers BCP1, BCP2 and BCP3 may not be dissolved in the first solvent 110.

Referring to FIG. 2B, a hydrophilic adsorbent 100 may be dissolved in the first solvent 110 to form a first adsorbent solution 130. The hydrophilic adsorbent 100 may include an inorganic particle, e.g., a silica particle or a zirconia particle. The hydrophilic adsorbent 100 may include at least one pore or pores (not shown) thereon. The first adsorbent solution 130 may be stirred, and thus, the hydrophilic adsorbent 100 may be dispersed well in the first solvent 110 and the first solvent 110 may also be provided into the pore or pores of the hydrophilic adsorbent 100.

Referring to FIG. 2C, the first polymer solution 120 of FIG. 2A may be mixed with the first adsorbent solution 130 of FIG. 2B to form a first mixture solution 140. The hydrophilic adsorbent 100 may interact with a hydrophilic polymer, e.g., the first homopolymer HP1 or the first polymer block P1, P1′, or P1″ in the block copolymer BCP1, BCP2, or BCP3. If the size, the proportion or the fraction of the first polymer block P1, P1′, or P1″ of the block copolymer BCP1, BCP2, or BCP3 is greater than a predetermined or particular size, the Interaction between the hydrophilic adsorbent 100 and the block copolymer BCP1, BCP2, or BCP3 may be sufficiently great so that the block copolymer may be adsorbed by the hydrophilic adsorbent 100. When dispersed in the first solvent 110, the hydrophilic adsorbent 100 may adsorb a polymer or block copolymer including a first polymer block having a molecular weight equal to or greater than the first molecular weight of the first polymer block P1, for example, as included in the first block copolymer BCP1. Thus, the first homopolymer HP1, the first block copolymer BCP1, and the second block copolymer BCP2 may be adsorbed on the hydrophilic adsorbent 100, so a first complex 150 may be formed. The hydrophilic adsorbent 100 may have pores, and thus, the first homopolymer HP1, the first block copolymer BCP1, and the second block copolymer BCP2 may be further adsorbed into the pores of the hydrophilic adsorbent 100. The first mixture solution 140 may be uniformly mixed by a stirring process, so the first homopolymer HP1, the first block copolymer BCP1, and the second block copolymer BCP2 may be more easily adsorbed onto the hydrophilic adsorbent 100. The first complex 150 may be dispersed in the first solvent 110.

If the first solvent 110 includes the main solvent of the volume ratio higher than 70 vol %, the first homopolymer HP1, the first block copolymer BCP1, and the second block copolymer BCP2 may interact more strongly with the first solvent 110 than with the hydrophilic adsorbent 100. Thus, the first homopolymer HP1, the first block copolymer BCP1, and the second block copolymer BCP2 may not be adsorbed onto the hydrophilic adsorbent 100. According to embodiments of the inventive concepts, the volume ratio of the main solvent in the first solvent 110 may be adjusted, and thus, the first homopolymer HP1, the first block copolymer BCP1, and the second block copolymer BCP2 may be adsorbed onto the hydrophilic adsorbent 100.

Since the second homopolymer HP2 and the third block copolymer BCP3 are hydrophobic in nature, these polymers may only have a weak interaction or even a repulsive interaction with the hydrophilic adsorbent 100. Thus, the second homopolymer HP2 and the third block copolymer BCP3 may not be adsorbed onto the hydrophilic adsorbent 100 and may remain in a dissolved state in the first solvent 110.

The formation of the first mixture solution 140 may be performed by at least one of various methods. In some embodiments, the formation of the first polymer solution 120 of FIG. 2A may be omitted, and the polymer product may be added directly into the first adsorbent solution 130 to form the first mixture solution 140. In other embodiments, the formation of the first adsorbent solution 130 of FIG. 2B may be omitted, and the hydrophilic adsorbent 100 may be added into the first polymer solution 120 to form the first mixture solution 140. In still other embodiments, the formation of both the first polymer solution 120 of FIG. 2A and the first adsorbent solution 130 of FIG. 2B may be omitted. In this case, the hydrophilic adsorbent 100 and the polymer product may be added into the first solvent 110 to form the first mixture solution 140.

Referring to FIG. 2D, the first mixture solution 140 of FIG. 2C may be filtered to separate the first complex 150 from the second homopolymer HP2 and the third block copolymer BCP3. Since the first complex 150 is not dissolved in the first mixture solution 140, the first complex 150 may remain on a filter 160. The second homopolymer HP2 and the third block copolymer BCP3 may pass together with the first solvent 110 through the filter 160.

The second homopolymer HP2 and the third block copolymer BCP3 may be precipitated, filtered, and dried to form a first block copolymer composition. The first block copolymer composition may include the second homopolymer HP2 and the third block copolymer BCP3 and may have a composition ratio different from that of the polymers synthesized in FIG. 1. For example, an average weight ratio of the first polymer block P1″ in the third block copolymer BCP3 of the first block copolymer composition may be lower than that of the first polymer block P1 in the first block copolymer BCP1 of the polymer product synthesized in FIG. 1.

Referring to FIG. 2E, the first complex 150 of FIG. 2D may be dissolved in a first desorption solvent 170, and thus, the first homopolymer HP1, the first block copolymer BCP1, and the second block copolymer BCP2 may be separated from the adsorbent 100. For example, the first desorption solvent 170 may include the solvent having the high solubility with respect to the polymer, as described with reference to FIG. 2A. For example, the first desorption solvent 170 may include one of tetrahydrofuran (THF), triethylamine (TEA), dimethylformamide (DMF), ethyl acetate, dimethyl sulfoxide (DMSO), or any combination thereof. The first homopolymer HP1, the first block copolymer BCP1, and the second block copolymer BCP2 may interact more strongly with the first desorption solvent 170 than with the hydrophilic adsorbent 100, and thus, the first homopolymer HP1, the first block copolymer BCP1, and the second block copolymer BCP2 may be desorbed from the hydrophilic adsorbent 100. A precipitating process, a filtering process, and a drying process may be performed on the first homopolymer HP1, the first block copolymer BCP1, and the second block copolymer BCP2 which are desorbed. The precipitating process may be performed using a solvent having low solubility with respect to a polymer, e.g., an alcohol solvent such as methanol or alcohol. The first homopolymer HP1, the first block copolymer BCP1, and the second block copolymer BCP2 may constitute a second block copolymer composition.

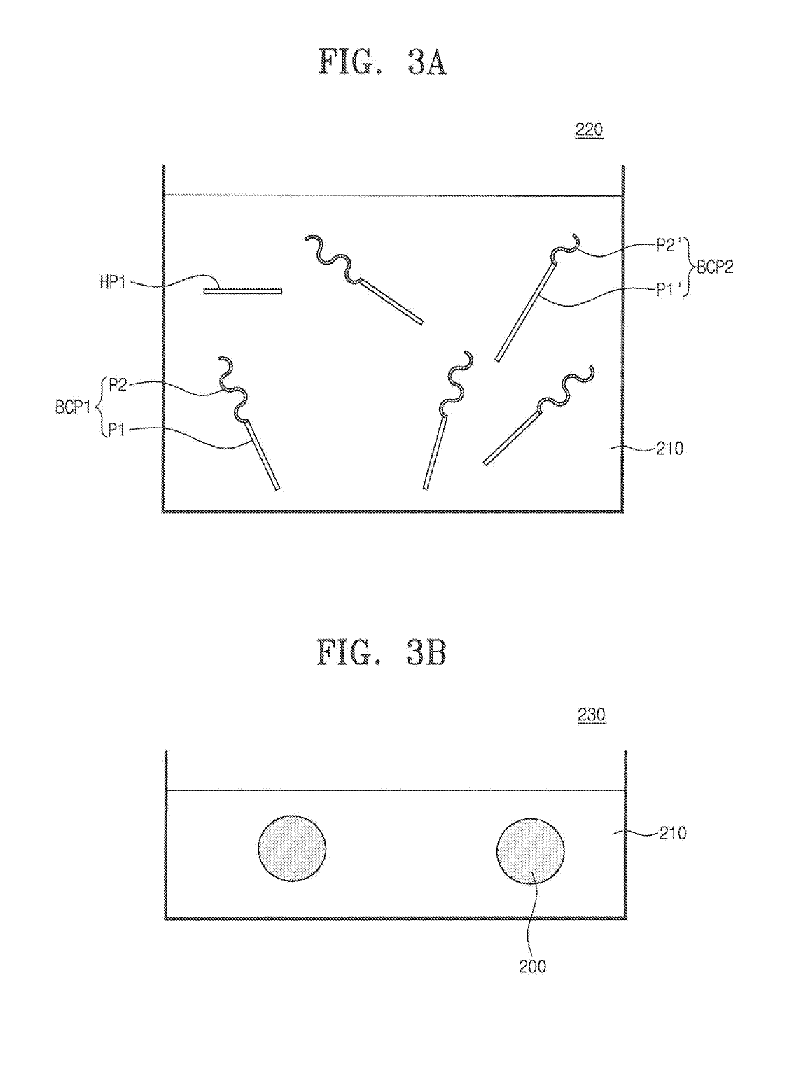

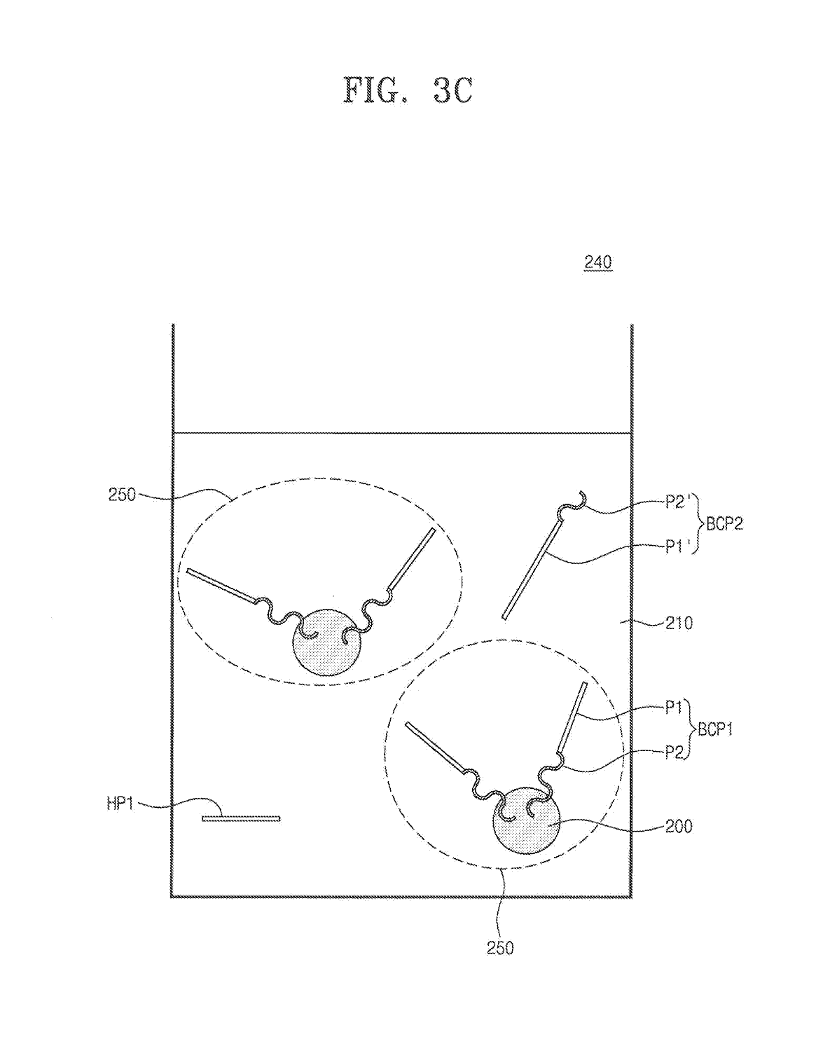

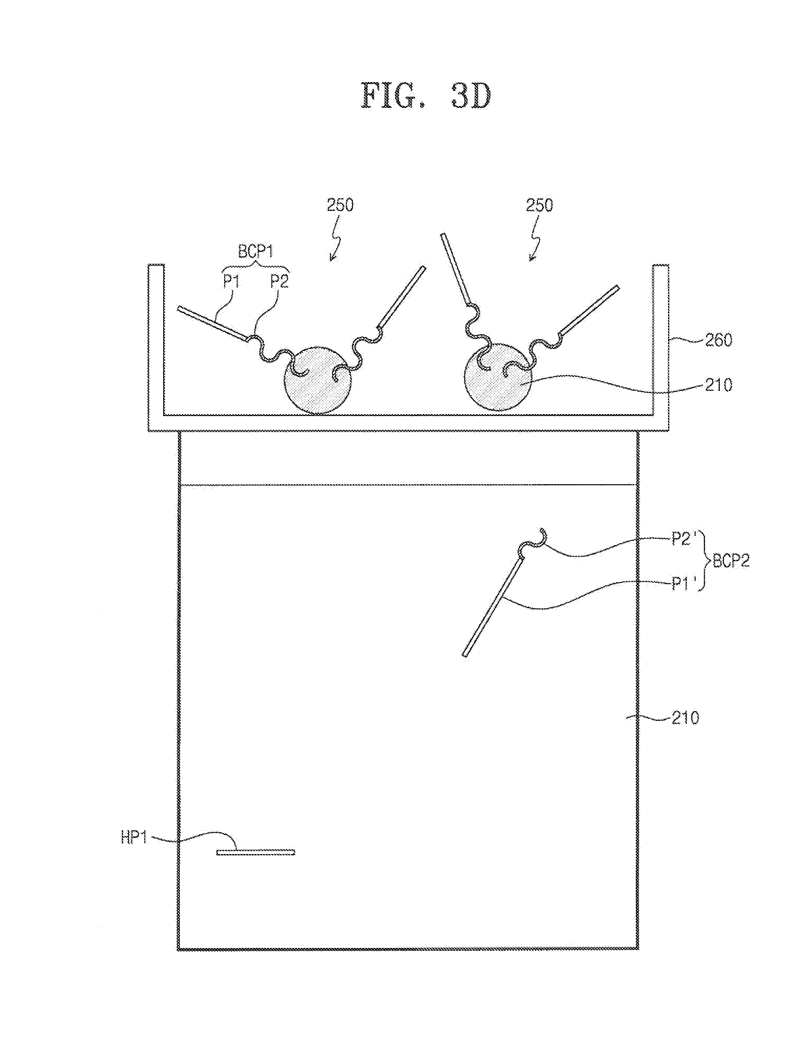

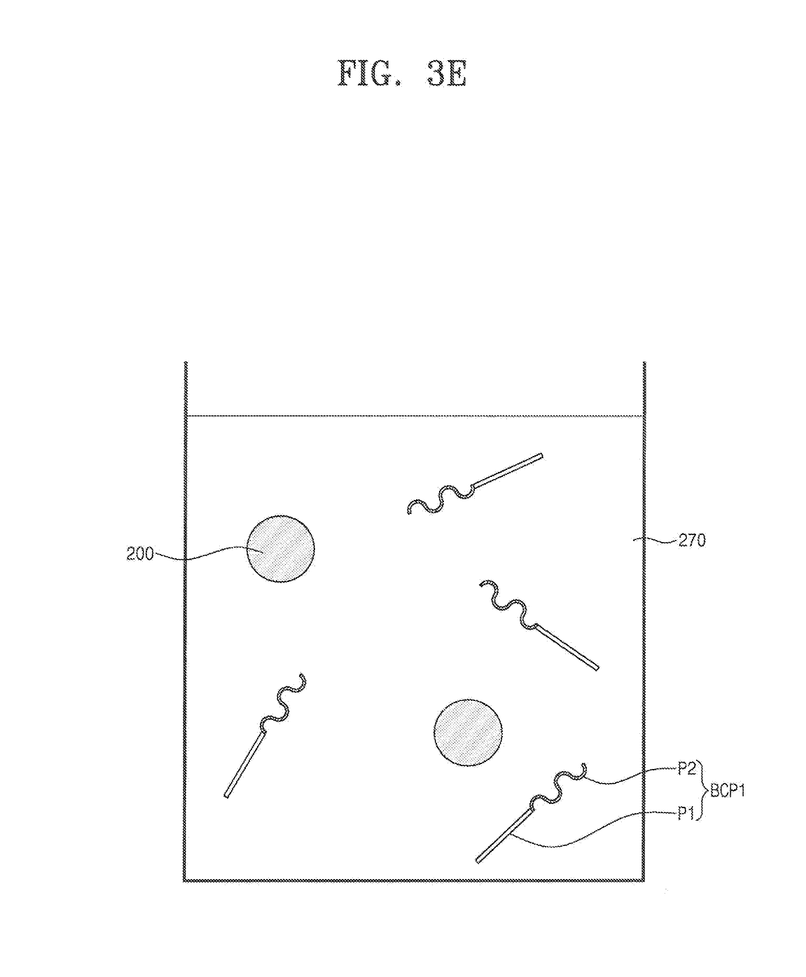

Hereinafter, a second purifying process according to example embodiments will be described with reference to FIGS. 3A to 3E. In the present embodiment, the descriptions to the same features as in the above embodiment will be omitted or mentioned briefly to avoid duplication of explanation.

Referring to FIG. 3A, the first homopolymer HP1, the first block copolymer BCP1, and the second block copolymer BCP2 may be added into a second solvent 210 to form a second polymer solution 220. The second solvent 210 may include a main solvent or a co-solvent. The main solvent may include at least one of solvents having high solubility with respect to a polymer. For example, the main solvent may include methylene chloride. The co-solvent may include acetonitrile. A solubility of the co-solvent with respect to the polymer may be lower than that of the main solvent with respect to the polymer. The second solvent 210 may include the main solvent of about 50 vol % to about 70 vol %. If the volume ratio of the main solvent is lower than 50 vol % in the second solvent 210, the first homopolymer HP1, the first block copolymer BCP1, and the second block copolymer BCP2 may not be dissolved in the second solvent 210.

Referring to FIG. 3B, a hydrophobic adsorbent 200 may be dissolved in a second solvent 210 to form a second adsorbent solution 230. The hydrophobic adsorbent 200 may include at least one inorganic particle coated with a functional group. For example, the hydrophobic adsorbent 200 may include a silica particle or zirconia particle which is coated with a hydrocarbon chain. For example, the hydrophobic adsorbent 200 may include a silica particle coated with an alkyl chain having a carbon number of 18. The hydrophobic adsorbent 200 may include at least one pore or pores (not shown) therein. The second adsorbent solution 230 may be stirred, so the hydrophobic adsorbent 200 may be dispersed well in the second solvent 210 and the second solvent 210 may also be provided into the pore or pores of the hydrophobic adsorbent 200. The second solvent 210 of FIG. 3B may be the same as the second solvent 210 of FIG. 3A. However, the inventive concepts are not limited thereto.

Referring to FIGS. 3C and 1, the second adsorbent solution 230 of FIG. 3B may be mixed with the second polymer solution 220 of FIG. 3A to form a second mixture solution 240 including a second complex 250. The hydrophobic adsorbent 200 may interact with the second homopolymer HP2 of FIG. 1 and the second polymer block P2 of the block copolymer BCP1 or BCP2. At this time, if the size of the second polymer block P2 of the block copolymer BCP1 or BCP2 is greater than a predetermined or particular size, the interaction between the hydrophobic adsorbent 200 and the block copolymer BCP1 or BCP2 may be sufficiently great to perform adsorption interaction. In the second solvent 210, the hydrophobic adsorbent 200 may adsorb a block copolymer including a second polymer block P2 having a molecular weight equal to or greater than the first molecular weight of the first polymer block P1 in the block copolymer. In an embodiment, the first block copolymer BCP1 may be adsorbed onto the hydrophobic adsorbent 200, so the second complex 250 may be formed. The second mixture solution 240 may be uniformly mixed by a stirring process, so the first block copolymer BCP1 may be more easily adsorbed onto the hydrophobic adsorbent 200. The hydrophobic adsorbent 200 may have pores, and thus, the first block copolymer BCP1 may be further adsorbed into the pores of the hydrophobic adsorbent 200. The second mixture solution 240 may be uniformly mixed by a stirring process, so that the first block copolymer BCP1 may be more easily adsorbed onto the hydrophobic adsorbent 200. The second complex 250 may be dispersed in the second solvent 210.

If the volume ratio of the main solvent is higher than 70 vol % in the second solvent 210, the first block copolymer BCP1 may interact more strongly with the second solvent 210 than with the hydrophobic adsorbent 200. In this case, the first block copolymer BCP1 may not be adsorbed onto the hydrophobic adsorbent 200. According to embodiments of the inventive concepts, the volume ratio of the main solvent in the second solvent 210 may be adjusted, and thus, the first block copolymer BCP1 may be adsorbed onto the hydrophobic adsorbent 200.

Since the first homopolymer HP1 is hydrophilic in nature, it may not be adsorbed onto the hydrophobic adsorbent 200. The second block copolymer BCP2 may include the first polymer block P1′ of a high molecular weight and the second polymer block P2′ of a low molecular weight. For example, the molecular weight of the second polymer block P2′ may be less than the molecular weight of the first polymer block P1′ in the second block copolymer BCP2. As such, the interaction between the second polymer block P2′ of the second block copolymer BCP2 and the hydrophobic adsorbent 200 may thus be insufficient to adsorb the second block copolymer BCP2 onto the hydrophobic adsorbent 200. The first homopolymer HP1 and the second block copolymer BCP2 may remain in a dissolved state in the second solvent 210.

The formation of the second mixture solution 240 may be performed by at least one of various methods. In another embodiment, the formation of the second polymer solution 220 of FIG. 3A may be omitted, and the first homopolymer HP1, the first block copolymer BCP1, and the second block copolymer BCP2 may be added into the second adsorbent solution 230. In still another embodiment, the formation of the second adsorbent solution 230 of FIG. 3B may be omitted, and the hydrophobic adsorbent 200 may be added into the second polymer solution 220. In yet another embodiment, the hydrophobic adsorbent 200, the first homopolymer HP1, the first block copolymer BCP1, and the second block copolymer BCP2 may be added into the second solvent 210 to form the second mixture solution 240.

Referring to FIG. 3D, the second mixture solution 240 may be filtered to separate the second complex 250 from the first homopolymer HP1 and the second block copolymer BCP2. Since the second complex 250 is not dissolved in the second mixture solution 240, the second complex 250 may remain on a filter 160. The first homopolymer HP1 and the second block copolymer BCP2 may pass together with the second solvent 210 through the filter 260.

A precipitating process, a filtering process, and a drying process may be performed on the first homopolymer HP1 and the second block copolymer BCP2 to form a third block copolymer composition. A composition ratio of the third block copolymer composition may be different from that of the polymers synthesized in FIG. 1, the first block copolymer composition of FIG. 2D or the second block copolymer composition. For example, the third block copolymer composition may include the first polymer block P1 having a relatively high content ratio.

Referring to FIG. 3E, the second complex 250 of FIG. 3D may be dissolved in a second desorption solvent 270, and thus, the first block copolymer BCP1 may be separated from the hydrophobic adsorbent 200. For example, the second desorption solvent 270 may include a solvent having high solubility with respect to a polymer. The second desorption solvent 270 may include, but not limited to, methylene chloride. The first block copolymer BCP1 may interact more strongly with the second desorption solvent 270 than with the hydrophobic adsorbent 200, and thus, the first block copolymer BCP1 may be desorbed from the hydrophobic adsorbent 200. A precipitating process, a filtering process, and a drying process may be performed on the second desorption solvent 270 including the first block copolymer BCP1 desorbed.

Unlike the embodiment described with reference to FIGS. 3A to 3E, the first purifying method may be performed after the second purifying method is performed. The second polymer block P2 in the first block copolymer BCP1 may have a first molecular weight. The molecular weight of the second polymer block P2′ in the second block copolymer BCP2 may be smaller than the first molecular weight P1′ in the second polymer block BCP2. The molecular weight of the second polymer block P2″ in the third block copolymer BCP3 may be greater than the first molecular weight P1″ in the third block copolymer BCP3. In this case, the second homopolymer HP2, the first block copolymer BCP1, and the third block copolymer BCP3 may be adsorbed onto the hydrophobic adsorbent 200 to form the second complex 250. Since the first homopolymer HP1 and the second block copolymer BCP2 are not adsorbed onto the hydrophobic adsorbent 200, they may pass through the filter 260 during the filtering process of FIG. 3D. Thereafter, the first block copolymer BCP1 may be adsorbed onto the hydrophilic adsorbent 100 to form the first complex 150. Since the second homopolymer HP2 and the third block copolymer BCP3 are not adsorbed onto the hydrophilic adsorbent 100, they may pass through the filter 160 during the filtering process of FIG. 2D.

In still another embodiment, one of the first purifying method or the second purifying method may be omitted. In yet another embodiment, the first purifying method or the second purifying method may be performed multiple times, so the first block copolymer BCP1 may become more pure.

It may be difficult to improve the block copolymer BCP1, BCP2, or BCP3 of FIG. 1 by controlling a synthesis method or a synthesis condition. According to embodiments of the inventive concepts, the hydrophilic adsorbent 100 and the hydrophobic adsorbent 200 may be used to remove the homopolymers from the polymer product. In addition, the block copolymers (e.g., the second and third block copolymers BCP2 and BCP3) having a different composition ratio from the first block copolymer BCP1 may also be removed to purify the first block copolymer BCP1 with higher purity. Limitations of the synthesis method used to form the block copolymer may be reduced or minimized by the purifying methods according to embodiments of the inventive concepts.

A method of forming a pattern according to example embodiments will be described hereinafter.

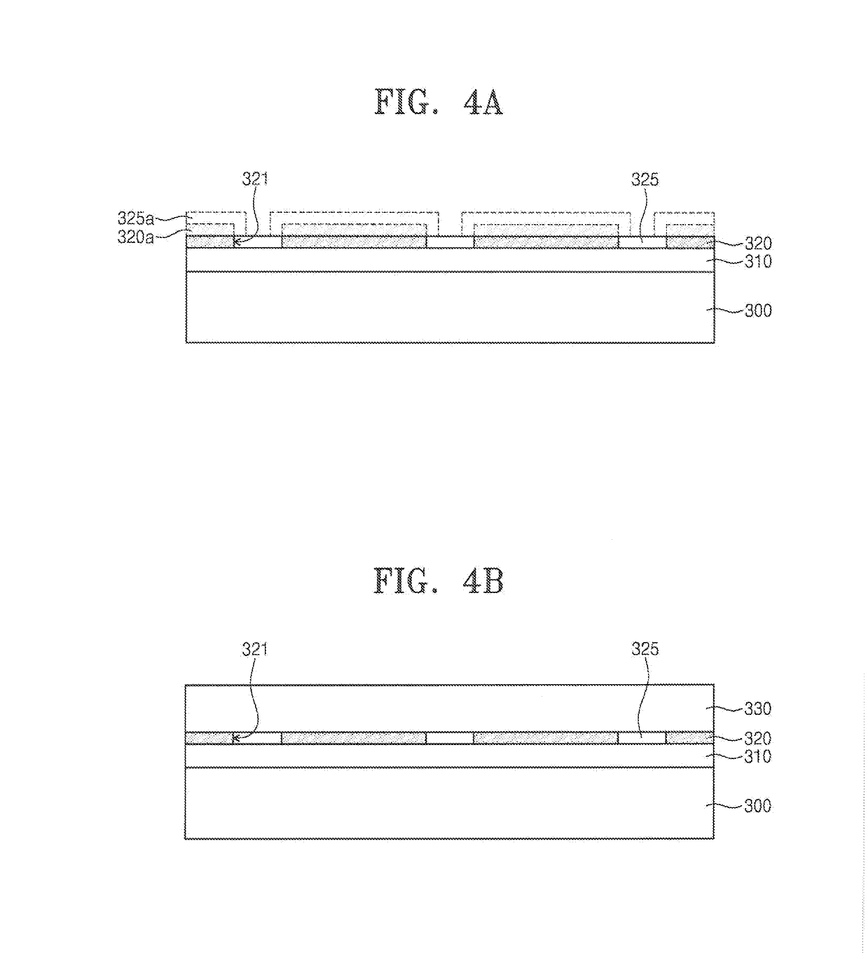

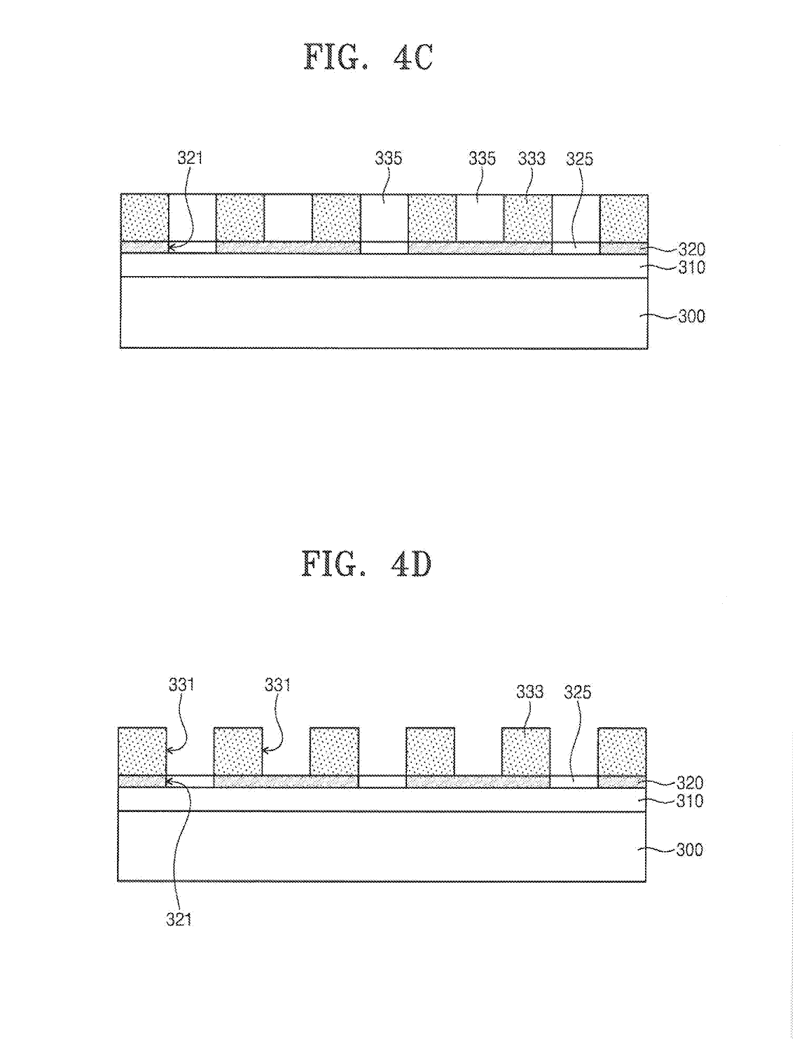

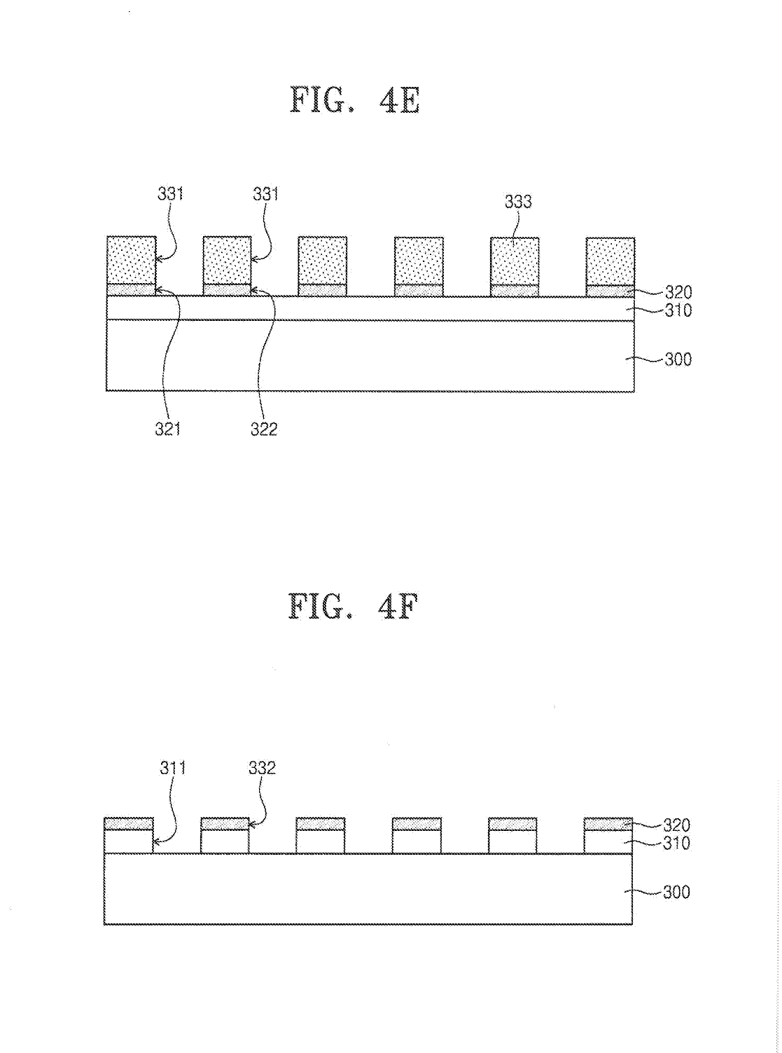

FIGS. 4A to 4F are cross-sectional views illustrating a method of forming a pattern according to embodiments of the inventive concepts. Hereinafter, the descriptions to the same features as in the above embodiments will be omitted or mentioned briefly to avoid duplication of explanation.

Referring to FIG. 4A, a lower layer 310, a guide pattern 320, a neutral pattern 325 may be formed on a substrate 300. According to an embodiment, the lower layer 310 may be formed of a semiconductor material, a conductive material, an insulating material, or any combination thereof. The lower layer 310 may be a single layer or a multi-layer including a plurality of stacked layers. The guide pattern 320 may be formed on the lower layer 310. The guide pattern 320 may have a hydrophilic functional group or hydrophobic functional group disposed on its surface. Hereinafter, the guide pattern 320 having the hydrophilic functional group will be described as an example. However, the inventive concepts are not limited thereto. The guide pattern 320 may have at least one guide opening 321 exposing the lower layer 310. The guide pattern 321 may have one of various shapes. For example, the guide opening 321 may have a linear shape extending in one direction or a hole shape when viewed from a plan view. The neutral pattern 325 and the guide pattern 320 may be alternately arranged. For example, the neutral pattern 325 may be provided in the guide opening 321 to fill the guide opening 321. The neutral pattern 325 may include a material that does not have selectivity with respect to hydrophilic property or hydrophobic property. Forming the neutral pattern 325 may include forming a neutral layer 325a on the lower layer 310 and the guide pattern 320, and removing a portion of the neutral layer 325a to expose a top surface of the guide pattern 320. A portion 320a of the guide pattern 320 may be also removed during an etching process of the neutral layer 325a. In another embodiment, one of the guide pattern 320 and the neutral pattern 325 may be omitted in the method of forming a pattern according to embodiments of the inventive concept.

Referring to FIG. 4B, a block copolymer layer 330 may be formed by depositing a block copolymer on the substrate 100. At this time, the first block copolymer BCP1 purified as described with reference to FIGS. 2A to 2E and 3A to 3E may be used to form the block copolymer layer 330. In other embodiments, the first block copolymer composition of FIG. 2D, the second block copolymer composition of FIG. 2E, or the third block copolymer composition of FIG. 3D may be used to form the block copolymer layer 330. The first polymer blocks P1 and the second polymer blocks P2 may be randomly mixed with each other in the block copolymer layer 330.

Referring to FIGS. 4C and 1, the block copolymer layer 330 may be thermally treated to form first block portions 333 and second block portions 335. The first block portions 333 may include the first polymer block P1 of FIG. 1, so the first block portions 333 may have a high affinity with respect to the hydrophilic functional group. Thus, the first block portions 333 may be formed on the guide pattern 320. The second block portions 335 may include the second polymer block P2 of FIG. 1, so the second block portions 335 may have a low affinity with respect to the hydrophilic functional group. The second block portions 335 may be formed on the guide pattern 320. In addition, the second block portion 335 may also be formed on the neutral pattern 325 between the first block portions 333. Shapes of the first and second block portions 333 and 335 may be variously controlled by controlling a weight ratio of the first and second polymer blocks P1, P1′ and P′1′, or P2, P2′, and P2″ in the block copolymer BCP1, BCP2, or BCP3 of FIG. 1, a shape of the guide pattern 320, and/or a material of the guide pattern 320. Hereinafter, the shapes of the first and second block portions 333 and 335 will be described in more detail.

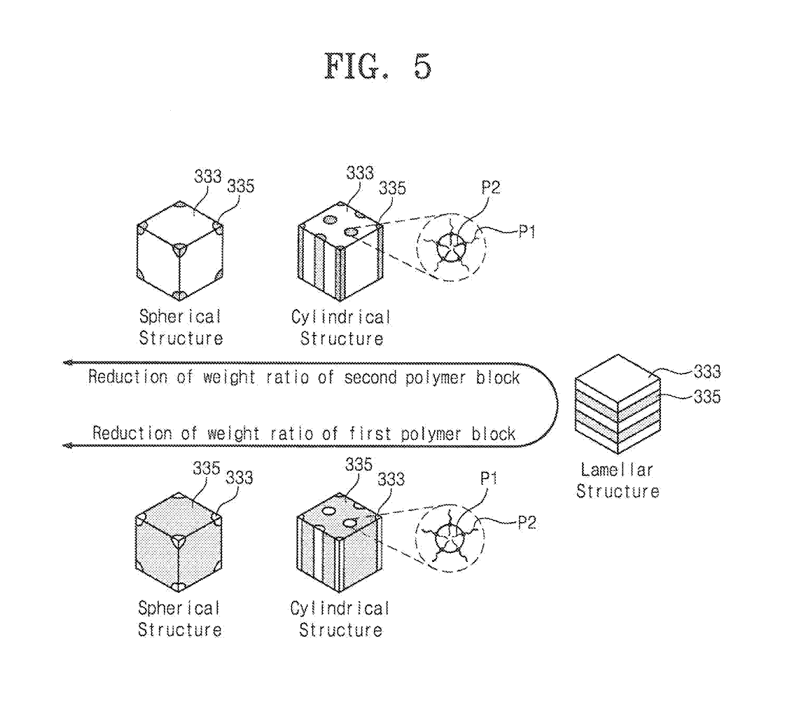

FIG. 5 illustrates shape changes of a first block portion and a second block portion during phase change of a block copolymer according to example embodiments of the inventive concepts.

Referring to FIGS. 5 and 1, when a phase of the block copolymer is changed, the shapes of the first and second block portions 333 and 335 may be dependent on the weight ratios of the first and second polymer blocks P1 and P2 of the used block copolymer. For example, if the phase of the first block copolymer BCP1 is changed, the first block portions 333 and the second block portions 335 may constitute a lamellar structure. The lamellar structure may mean a layered structure including the first block portions 333 and the second block portions 335 which are alternately stacked.

If the phase of the second block copolymer BCP2 is changed, each of the second block portions 335 may have a cylindrical structure or a spherical structure. The weight ratio of the second polymer block P2′ in the second block copolymer BCP2 may be lower than that of the second polymer block P2 in the first block copolymer BCP1. The second polymer blocks P2′ may constitute a cylindrical array including the cylindrical structures regularly arranged, and each of the cylindrical structures may correspond to the second block portion 335. The first polymer blocks P1′ may be formed into a polymer matrix surrounding the second block portions 335 having the cylindrical structures, and the polymer matrix may correspond to the first block portion 333. If the content of the second polymer blocks P2′ is further reduced, the second polymer blocks P2′ may constitute a spherical array including the spherical structures regularly arranged, and the first polymer blocks P1′ may be formed into a polymer matrix surrounding the spherical structures.

If the weight ratio of the first polymer block P1 is reduced, a phenomenon opposite to the above mentioned phenomenon may occur. Thus, if the phase of the third block copolymer BCP3 is changed, each of the first block portions 333 may have a cylindrical shape or a spherical shape.

According to embodiments of the inventive concepts, the kind of the adsorbent and/or the composition ratio of the solvent may be adjusted to control the type of the purified block copolymer to be purified. For example, the second block copolymer BCP2 may be purified with high purity, or the third block copolymer BCP3 may be purified with high purity. The composition of the purified block copolymer BCP1, BCP2, or BCP3 may be controlled to adjust the shapes of the first and second block portions 333 and 335 formed by the block copolymer.

A plurality of block copolymers BCP1, BCP2, and BCP3 may be generally formed by a plurality of polymerizations, respectively. However, according to embodiments of the inventive concepts, the polymer product including a plurality of block copolymer compositions may be formed by the single polymerization described with reference to FIG. 1. For example, the polymer product formed by the single polymerization may be divided into the first block copolymer composition of FIG. 2D and the second block copolymer composition of FIG. 2E and/or the third block copolymer composition of FIG. 3D and the first block copolymer BCP1 of FIG. 3E by the purifying process. The first block portion 333 and the second block portion 335 formed using the first to third block copolymer compositions and the first block copolymer BCP1 may have different shapes from each other. According to embodiments of the inventive concepts, various kinds of the block copolymer compositions may be easily separated from each other.

Referring again to FIG. 4C, if the block copolymer BCP1, BCP2, or BCP3 of FIG. 1 with low purity is used, widths of the first and second block portions 333 and 335 may be relatively wide. For example, if the block copolymer BCP1 of FIG. 1 includes the homopolymer HP1 and/or HP2 and/or the second and/or third block copolymers BCP2 and/or BCP3, the block portions 333 and 335 may have wide widths. According to embodiments of the inventive concepts, the hydrophilic adsorbent 100 and the hydrophobic adsorbent 200 may be used to purify the first block copolymer BCP1 with high purity. The first block copolymer BCP1 may be used to form the first and second block portions 333 and 335 having relatively small widths.

Referring to FIG. 4D, the second block portions 336 may be removed to form first openings 331. The second block portions 335 may be removed by a dry etching process or a wet etching process. The first block portions 333 may have an etch selectivity with respect to the second block portions 336. The first openings 331 may expose a top surface of the guide pattern 320 and a top surface of the neutral pattern 325. Alternatively, the first openings 331 may be formed by removing the first block portions 333.

Referring to FIG. 4E, the guide pattern 320 and the neutral pattern 325 exposed by the first openings 331 may be removed. The removal of the guide pattern 320 and the neutral pattern 325 may be performed using an etching process. As a result, the guide pattern 320 may have the guide openings 321 and second openings 322. The guide openings 321 and the second openings 322 may expose the lower layer 310.

Referring to FIG. 4F, the first block portions 333 of FIG. 4E may be removed. The lower layer 310 exposed by the guide openings 321 and the second openings 322 may be etched to form lower openings 311. The guide pattern 320 may be used as an etch mask during the etching process performed on the lower layer 310. If the first openings 331 and the second openings 322 are formed by a photolithography process, widths and pitches of the first openings 331 and the second openings 322 may be limited by a resolution limitation of the photolithography process. However, according to embodiments of the inventive concepts, the second openings 322 may be formed using the block copolymer layer 330, and thus, the second openings 322 may be free from the resolution limitation of the photolithography process. According to embodiments of the inventive concepts, the widths and a dispersion of the second openings 322 may be easily controlled. Thereafter, the guide pattern 320 may be removed.

Hereinafter, characteristics of the purifying methods and the purified block copolymers according to embodiments of the inventive concepts will be described with reference to experimental examples according to inventive concepts and comparison examples.

Formation of a Block Copolymer Composition and Purification of a Block Copolymer

### Comparison Example 1

### Formation of as-Synthesized PS-b-PMMA

Methyl methacrylate (MMA) monomers and azobisisobutyronitrile (AIBN) were dissolved in benzene contained in a reactor to form a mixture. The AIBN acts as an initiator and a chain transfer agent. The reactor was then heated at 70° C. for 5 hours to perform the polymerization of the mixture. Styrene monomers were dissolved in benzene to form a styrene solution. The styrene solution was then added to the mixture. The mixture provided with the styrene solution was then heated at 115° C. for 20 hours to perform the polymerization of the styrene and the mixture and thus to form a polymer product. The polymer product was dissolved in dichloromethane, and then an alcoholic solvent was added into the dichloromethane including the polymer product to form a precipitate. Dissolving the precipitate in dichloromethane and adding the alcoholic solvent were alternately repeated to form the as-synthesized polystyrene-block-polymethyl methacrylate.

### Experimental Example 1-1

### First Purifying Method: Formation of a First Block Copolymer Composition

The first purifying method described with reference to FIGS. 2A to 2D was performed on the as-synthesized polystyrene-block-polymethyl methacrylate of the comparison example 1. In more detail, one liter of the first solvent was formed by mixing tetrahydrofuran (THF) and isooctane (IO) with each other at a volume ratio of 60:40. The polymer product of comparison example 1 was dissolved in the one liter of the first solvent to form the first polymer solution. An excessive quantity of silica particles was dispersed in the first solvent to form the first adsorbent solution. After the first adsorbent solution and the first polymer solution were mixed each other, the mixed solutions were stirred for 2 hours to form the first mixture solution. The first mixture solution was filtered through a filter paper to separate the silicon particles adsorbing polymer from the first mixture solution. The filtered first mixture solution was cleaned using tetrahydrofuran, and the cleaned product was concentrated. The concentrated product was injected into two liters of methanol to precipitate the first block copolymer composition remaining in the first solvent. The precipitated first block copolymer composition was dried in an oven at 50° C. for 3 days.

### Experimental Example 1-2

### First Purifying Method: Formation of a Second Block Copolymer Composition

The silica particles adsorbing the polymer, which remained on the filter paper, were cleaned by an excessive amount of tetrahydrofuran. The cleaned product was concentrated, and the concentrated product was injected into 2 liters of methanol to precipitate the polymer. Cleaning the polymer and precipitating the polymer were alternately repeated. The precipitated polymer was dried in an oven at 50° C. for 3 days, thereby forming the second block copolymer composition.

### Experimental Example 1-3

### Second Purifying Method: Formation of a Third Block Copolymer Composition

The second purifying method described with reference to FIGS. 3A to 3D was performed on the second block copolymer composition formed in the experimental example 1-2. In more detail, methylene chloride and acetonitrile were mixed with each other at a volume ratio of 60:40 to form one liter of the second solvent. The second block copolymer composition was dissolved in the one liter of the second solvent to form the second polymer solution. An excessive amount of silicon particles coated with C18H37dl (hereinafter, referred to as ‘C18 silica particles’) was dispersed in the second solvent to form the second adsorbent solution. The second adsorbent solution and the second polymer solution were mixed with each other and were then stirred for 2 hours to form the second mixture solution. The second mixture solution was filtered by a filter paper, so the C18 silica particles adsorbing the polymer were separated from the second mixture solution. The filtered second mixture solution was cleaned using methylene chloride, and then, the cleaned product was concentrated. The concentrated product was injected into two liters of methanol to precipitate the third block copolymer composition remaining in the second solvent. The precipitated third block copolymer composition was dried in an oven at 50° C. for 3 days.

### Experimental Example 1-4

### Second Purifying Method, Purification of a First Block Copolymer

The C18 silica particles remaining the filter paper and adsorbing the polymer were cleaned using an excessive amount of methylene chloride. The cleaned product was concentrated, and the concentrated product was injected into two liters of methanol to precipitate the copolymer. Cleaning and precipitating the polymer were alternately repeated. The precipitated copolymer was dried in an oven at 50° C. for 3 days to obtain the first block copolymer which was purified.

Method of Forming a Pattern

### Comparison Example 2

### Formation of as-Synthesized PS-b-PMMA

A block copolymer was coated on a substrate to form a block copolymer layer. Heat was applied to the block copolymer layer to form a first block portion and a second block portion. At this time, the as-synthesized polystyrene-block-polymethylmethacrylate of the comparison example 1 was used as the block copolymer. Shapes and widths of the first and second block portions were measured.

### Experimental Example 2-1

### First Purifying Method, Formation of a First Block Copolymer Composition

A first portion and a second portion were formed by the same method as the comparison example 2. However, in the present experimental example, the first block copolymer composition formed in the experimental example 1-1 was used as the block copolymer.

### Experimental Example 2-2

### First Purifying Method, Formation of a Second Block Copolymer Composition

A first portion and a second portion were formed by the same method as the comparison example 2. However, in the present experimental example, the second block copolymer composition formed in the experimental example 1-2 was used as the block copolymer.

### Experimental Example 2-3

### Second Purifying Method, Formation of a Third Block Copolymer Composition

A first portion and a second portion were formed by the same method as the comparison example 2. However, in the present experimental example, the third block copolymer composition formed in the experimental example 1-3 was used as the block copolymer.

### Experimental Example 2-4

### Second Purifying Method, Purification of a First Block Copolymer

A first portion and a second portion were formed by the same method as the comparison example 2. However, in the present experimental example, the purified first block copolymer obtained in the experimental example 1-4 was used as the block copolymer.

Solubility of Polymers According to Composition of Solvent

### Comparison Example 3-1

### Silica Particle Adsorbent, Tetrahydrofuran Solvent

A first mixture solution was formed by the same method as the experimental example 1-1. However, in the present comparison example, tetrahydrofuran was used as the first solvent and isooctane was not added. The first mixture solution separated by chromatography (HPLC) and UV absorption at a wavelength of 254 nm was measured of the eluent and analyzed according to a retention time. At this time, a volume ratio of the tetrahydrofuran in the first solvent was increased from 55 vol % to 100 vol % at a rate of 10 vol %/min.

### Comparison Example 3-2

### Silica Particle Adsorbent, Tetrahydrofuran Solvent

A first mixture solution was formed by the same method as the experimental example 1-1. However, in the present comparison example, tetrahydrofuran of a volume ratio lower than 50 vol % was added into the first solvent. In this case, the polymer product of the comparison example 1 was not dissolved in the tetrahydrofuran, so the first complex was not formed.

### Experimental Example 3-1

### Silica Particle Adsorbent, Mixture Solvent

A first mixture solution was formed by the same method as the experimental example 1-1. However, in the present experimental example, tetrahydrofuran and isooctane was mixed with each other at a volume ratio of 55:45 to form the first solvent. The first mixture solution was spread on a chromatography to measure a wavelength of 254 nm according to a retention time. At this time, a volume ratio of the tetrahydrofuran in the first solvent was increased from 55 vol % to 100 vol % at a rate of 10 vol %/min.

### Comparison Example 4-1

### C18 Silica Particle Adsorbent, PMMA Homopolymer

A second mixture solution was formed by the same method as the experimental example 1-3. However, in the present comparison example, a polymethylmethacrylate homopolymer was used instead of the second block copolymer composition formed in the experimental example 1-2. The second solvent formed by mixing methylene chloride and acetonitrile with each other at a volume ratio of 65:35 was used to form the second mixture solution. The second mixture solution was spread on a chromatography to measure a wavelength of 235 nm according to a retention time. The volume ratio of the methylene chloride was increased to 100 vol % at a rate of 10 vol %/min.

### Comparison Example 4-2

### C18 Silica Particle Adsorbent, PS Homopolymer

A second mixture solution was formed by the same method as the experimental example 1-3. However, in the present comparison example, a polystyrene homopolymer was used instead of the second block copolymer composition formed in the experimental example 1-2. The second solvent formed by mixing methylene chloride and acetonitrile with each other at a volume ratio of 65:35 was used to form the second mixture solution. The second mixture solution was spread on a chromatography to measure a wavelength of 235 nm according to a retention time. At this time, the volume ratio of the methylene chloride was increased to 100 vol % at a rate of 10 vol %/min.

### Comparison Example 4-3

### C18 Silica Particle Adsorbent, PS Homopolymer

A second mixture solution was formed using the same method as the comparison example 4-2. However, in the present comparison example, the volume ratio of methylene chloride of the second solvent was lower than 50 vol %. In this case, a polymer product was not dissolved in the methylene chloride, so the second mixture solution was not formed.

### Experimental Example 4-1

### C18 Silica Particle Adsorbent, Polymer Product of Comparison Example 1

A second mixture solution was formed by the same method as the experimental example 1-3. However, in the present experimental example, the polymer product of the comparison example 1 was used instead of the second block copolymer composition formed in the experimental example 1-2. The second solvent formed by mixing methylene chloride and acetonitrile with each other at a volume ratio of 65:35 was used to form the second mixture solution. The second mixture solution was spread on a chromatography to measure a wavelength of 235 nm according to a retention time. At this time, the volume ratio of the methylene chloride was increased to 100 vol % at a rate of 10 vol %/min.

Table 1 shows measurement values of physical/chemical parameters of the block copolymer compositions and the first block copolymer obtained in the comparison example 1 and the experimental examples 1-1 to 1-4.

TABLE 1

| | Weight-average | | Weight ratio (wt %) |
|---|---|---|---|
| | molecular weight | Poly dispersity | of first polymer |
| | (g/mol) | index (PDI) | block (PMMA) |
| Comparison | 39,000 | 1.44 | 0.50 |
| Example 1 | | | |
| Experimental | 53,000 | 1.46 | 0.30 |
| Example 1-1 | | | |
| Experimental | 62,000 | 1.14 | 0.51 |
| Example 1-2 | | | |
| Experimental | 47,000 | 1.20 | 0.77 |
| Example 1-3 | | | |
| Experimental | 80,000 | 1.09 | 0.52 |
| Example 1-4 | | | |

Referring to Table 1 and FIG. 1, the poly dispersity index (PDI) of the second block copolymer composition of the experimental example 1-2 is smaller than that of the polymer product of the comparison example 1. The PDI is defined as a value obtained by subtracting a number-average molecular weight (Mn) from the weight-average molecular weight (Mw). The weight-average molecular weight may mean a molecular weight obtained by averaging weights of polymer molecules in a sample. The number-average molecular weight may mean a molecular weight obtained by averaging numbers of polymer molecules in a sample. As the PDI approaches 1, a distribution of molecular weights may become narrower. Since the second block copolymer composition of the experimental example 1-2 is formed through the first purifying process, the second homopolymer HP2 and the third block copolymer BCP3 may be removed from the synthesized polymer product. It may be confirmed that the purity of the second block copolymer composition of the experimental example 1-2 is higher than that of synthesized polymer product of the comparison example 1.

The PDI of the first block copolymer BCP1 purified in the experimental example 1-4 more approaches 1, as compared with the PDIs of the second block copolymer composition of the experimental example 1-2 and the polymer product of the comparison example 1. Since the second purifying process is performed on the first block copolymer BCP1 purified in the experimental example 1-4, the first homopolymer HP1 and the second block copolymer BCP2 may also be removed from the second block copolymer composition of the experimental example 1-2. Thus, the purity of the first block copolymer BCP1 purified in the experimental example 1-4 is higher than those of the polymer product of the comparison example 1, the second block copolymer composition of the experimental example 1-2, and the third block copolymer composition of the experimental example 1-3.

It may be observed that the first block copolymer composition of the experimental example 1-1 has the first block copolymer BCP1 of a relatively low weight ratio. In the experimental example 1-1, it is confirmed that the first block copolymer composition includes a polymer not adsorbed on the hydrophilic adsorbent 100, e.g., the second homopolymer HP2 and the third block copolymer BCP3.

The third block copolymer composition of the experimental example 1-3 may include the second polymer block P2 of the first block copolymer BCP1, which has a relatively high weight ratio. In the experimental example 1-3, it is confirmed that the third block copolymer composition includes a polymer not adsorbed on the hydrophobic adsorbent 200, e.g., the first homopolymer HP1 and the second block copolymer BCP2.

Table 2 shows shapes of patterns formed by the comparison example 2 and the experimental examples 2-1 to 2-4.

TABLE 2

| | Cross-sectional shape of | |
|---|---|---|
| | pattern | Average width of pattern (nm) |
| Comparison | Lamellar structure | 40.7 |
| example 2 | | |
| Experimental | Cylindrical structure | — |
| example 2-1 | | |
| Experimental | Lamellar structure | 35.9 |
| example 2-2 | | |
| Experimental | Cylindrical structure | — |
| example 2-3 | | |
| Experimental | Lamellar structure | 37.2 |
| example 2-4 | | |

Referring to Tables 1 and 2 and FIGS. 1, 4C and 5, it may be observed that the patterns of the comparison example 2, the experimental example 2-2, and the experimental example 2-4 have the lamellar structure. Since the weight ratios of the first block copolymers of the comparison example 1, the experimental example 1-2, and the experimental example 1-4 are about 0.5, the first block portions 333 and the second block portions 335 of the comparison example 2, the experimental example 2-2, and the experimental example 2-4 may constitute the lamellar structure, as illustrated in FIG. 5. Since the purity of the first block copolymer BCP1 purified in the experimental example 1-4 is higher than that of the block copolymer of the comparison example 1 as described with reference to Table 1, the pattern of the experimental example 2-4 formed using the same may have the average width narrower than that of the pattern of the comparison example 2. Since the purity of the second block copolymer composition of the experimental example 1-2 is higher than that of the polymer product of the comparison example 1, the pattern of the experimental example 2-2 may have the average width narrower than that of the pattern of the comparison example 2.

Since the experimental example 1-1 includes the first polymer block P1″ of a relatively low weight ratio, the pattern of the experimental example 2-1 formed using the same may have the cylindrical structure. The first block portions 333 may include the first polymer block P1″ and may constitute the cylindrical-type array. The second block portion 335 may surround the first block portions 333.

Since the experimental example 1-3 includes the first polymer block P1′ of a relatively high weight ratio, the pattern of the experimental example 2-3 formed using the same may have the cylindrical structure. In this case, the second block portions 336 may constitute the cylindrical-type array, and the first block portion 333 may surround the second block portions 335.

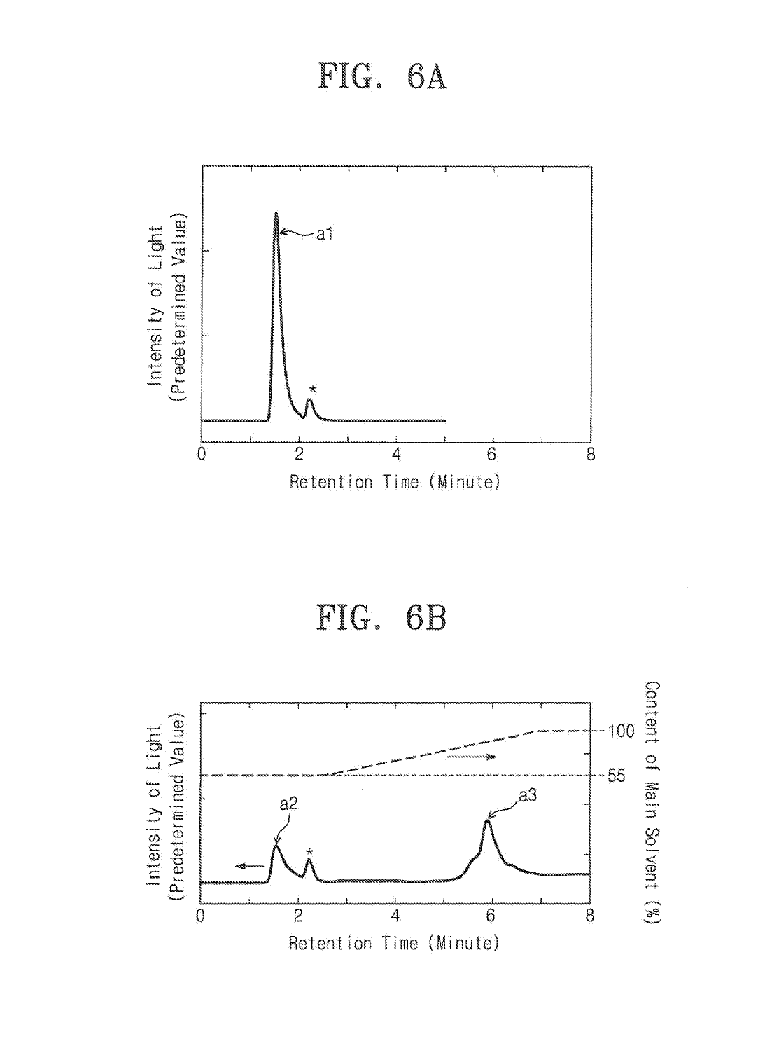

FIGS. 6A and 6B are graphs illustrating ultraviolet (UV) detection results of a comparison example 3-1 and an experimental example 3-1, respectively, separated by HPLC. In FIGS. 6A and 6B, a horizontal axis represents a retention time, and a left vertical axis represents an intensity of light (a predetermined value) in a wavelength of 254 nm.

Referring to FIG. 6A, tetrahydrofuran may have a high solubility with respect to a polymer to act as the main solvent. It is observed that a peak a1 of the polymer product of the comparison example 3-1 is detected at a relatively early retention time. If an excessive amount of the main solvent is included in the first solvent, the polymer product may interact more strongly with the first solvent than with the hydrophilic adsorbent (e.g., the silica particles). Thus, the polymer product may not be adsorbed on the hydrophilic adsorbent but may be still dissolved in the first solvent. As a result, the polymer product may be spread on the chromatography in an early time, so the peak a1 of the polymer product may be shown at the relatively early retention time. A peak * of another solvent may be further shown.

If the volume ratio of the main solvent in the first solvent is lower than 50 vol % as described in the experimental example 3-2, the first solvent may have low solubility. Thus, the polymer product may not be dissolved in the first solvent.

Referring to FIG. 6B, a peak a2 of the second homopolymer may be first shown, and then, a peak a3 of the block copolymer may be shown. At this time, polymethylmethacrylate may act as the first homopolymer, and polystyrene may act as the second homopolymer. The first homopolymer may have hydrophilic properties, so it may not be adsorbed on the hydrophobic adsorbent in the first solvent. The first homopolymer may be rapidly spread on the chromatography under the main solvent condition of 55 vol %, and thus, the peak a2 of the first homopolymer may be observed.

If the volume ratio of the main solvent increases, the peak a3 of the block copolymer may be shown. Here, since polystyrene does not emit light in the wavelength of 254 nm, a peak of the second homopolymer is not observed. The block copolymer may include a hydrophobic polymer, so it may interact with the hydrophobic adsorbent. In the experimental example 3-1, the block copolymer may be adsorbed on the hydrophobic adsorbent in the first solvent. In this case, the peak a3 of the block copolymer may not be shown. If the content of the main solvent increases in the first solvent, the interaction between the block copolymer and the first solvent may increase. If the volume ratio of the main solvent in the first solvent is higher than 70 vol %, the block copolymer may interact more strongly with the first solvent than with the adsorbent. Thus, the block copolymer may be desorbed from the adsorbent. The desorbed block copolymer may be spread on the chromatography, to the peak a3 of the block copolymer may be shown).

According to embodiments of the inventive concepts, the composition ratio of the first solvent may be adjusted to control adsorption and desorption of the block copolymer and the homopolymers.

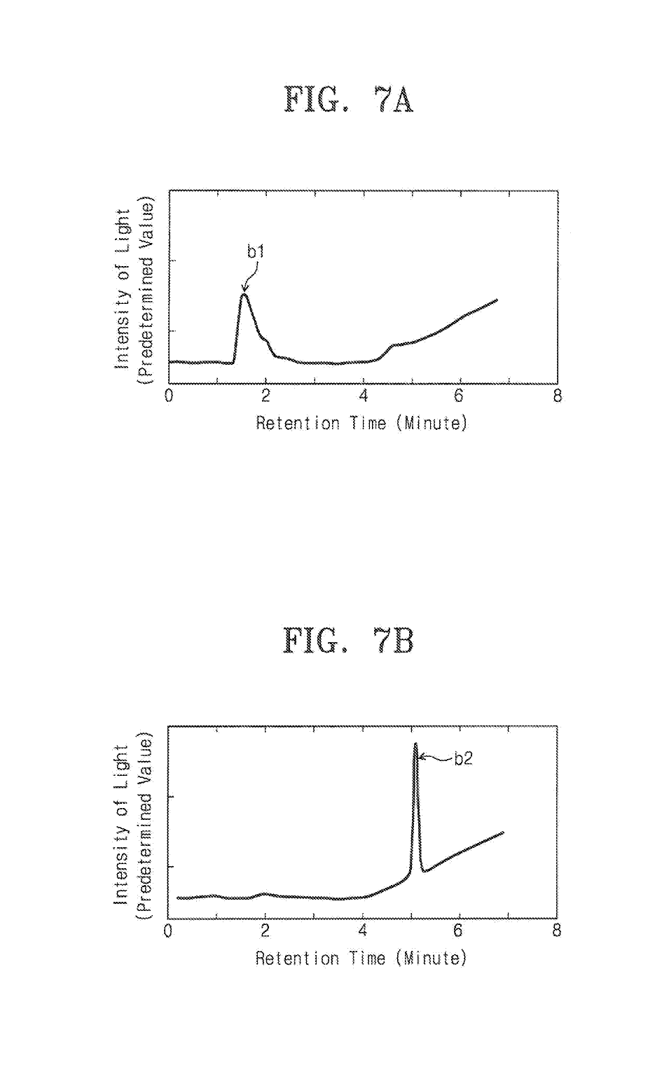

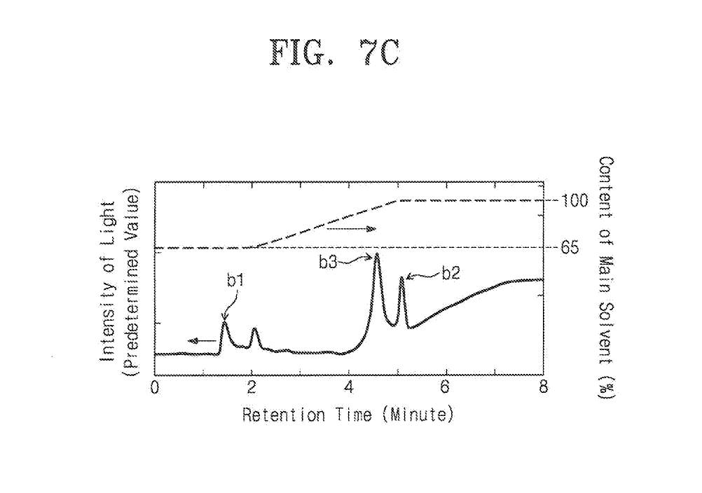

FIGS. 7A, 7B, and 7C are graphs illustrating UV detection results of a comparison example 4-1, a comparison example 4-2, and an experimental example 4-1, respectively, separated by HPLC. In FIGS. 7A, 7B, and 7C, a horizontal axis represents a retention time, and a left vertical axis represents an intensity of light (a predetermined value, a.u.) in a wavelength of 235 nm. Hereinafter, the same descriptions as described above will be omitted or mentioned briefly to avoid duplication of explanation.

Referring to FIG. 7A, a peak b1 of the first homopolymer of the comparison example 4-1 may be observed in a relatively short retention time. The first homopolymer may have the hydrophilic functional group, and thus, it may be difficult to be adsorbed on the hydrophobic adsorbent. Since the first homopolymer is dissolved in the second solvent under the main solvent condition of 65 vol %, the first homopolymer is spread on the chromatography in a short time.

Referring to FIG. 7B, if the content ratio of the main solvent increases in the first solvent, a peak b2 of the second homopolymer of the comparison example 4-2 may be observed. In the comparison example 4-2, methylene chloride may act as the main solvent. If the volume ratio of the main solvent is 55 vol % in the second solvent, the second homopolymer having the hydrophobic property may be adsorbed on the hydrophobic adsorbent. In this case, the second homopolymer may be difficult to be spread on the chromatography. If the content ratio of the main solvent increases in the second solvent, the interaction between the second homopolymer and the second solvent may increase, but the interaction between the second homopolymer and the hydrophobic adsorbent may be reduced. It is confirmed that the second homopolymer is desorbed from the hydrophobic adsorbent if the volume ratio of the main solvent is higher than 70 vol % in the second solvent.

Referring to FIG. 7C, the peak b1 of the first homopolymer may be observed in a relatively short retention time. As the content ratio of the main solvent increases in the second solvent, a peak b3 of the block copolymer and the peak b2 of the second homopolymer may be sequentially observed. The block copolymer may include the first polymer block having the hydrophobic property and may be adsorbed on the hydrophobic adsorbent. If the volume ratio of the main solvent is 65 vol % in the second solvent, the block copolymer may be difficult to be spread on the chromatography. As the content ratio of the main solvent increases, the interaction between the block copolymer and the hydrophobic adsorbent may be reduced. It is confirmed that the block copolymer is desorbed from the hydrophobic adsorbent if the volume ratio of the main solvent is 70 vol % in the second solvent.

According to embodiments of the inventive concepts, the composition ratio of the second solvent may be controlled, and thus, the block copolymer and the homopolymers may be adsorbed on or desorbed from the hydrophobic adsorbent.

According to embodiments of the inventive concepts, the synthesized block copolymer may be purified using the hydrophobic adsorbent and the hydrophilic adsorbent. The hydrophobic adsorbent may have adsorbability with respect to the hydrophobic polymer having a molecular weight equal to or greater than a first average molecular weight in the first solvent. The composition ratio of the first solvent may be controlled, so the adsorption and desorption of the hydrophobic polymer may be controlled. The hydrophilic adsorbent may have adsorbability with respect to the hydrophilic polymer having a predetermined molecular weight or more in the second solvent. The composition ratio of the second solvent may be controlled, so the adsorption and desorption of the hydrophilic polymer may be controlled. The homopolymers may be removed from the block copolymer by the purifying method, and thus, the purified block copolymer may have high purity. According to the purifying method, other block copolymers having different composition ratios may be separated from the purified block copolymer, so the purified block copolymer may have higher purity.

According to embodiments of the inventive concepts, a plurality of block copolymer compositions may be separated from a single polymer product by the purifying method. Thus, the block copolymer compositions may be easily formed.

While the inventive concepts have been described with reference to example embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A method for purifying a block copolymer, the method comprising:
forming a first mixture solution by dissolving a block copolymer that comprises block copolymer products formed by polymerizing a first monomer and a second monomer and a first adsorbent in a first solvent, the first adsorbent having adsorbability with respect to block copolymer products comprising a first polymer block having a first molecular weight or more in the first solvent;
forming a first complex by adsorbing block copolymer products having adsorbability to the first adsorbent; and
separating the first complex from the first mixture solution.

2. The method of claim 1, wherein the block copolymer products have about the same or similar molecular weights.

3. The method of claim 1, further comprising:
forming a second mixture solution by dissolving block copolymer products that were adsorbed by the first adsorbent to form the first complex and a second adsorbent in a second solvent, the second adsorbent having adsorbability with respect to block copolymer products comprising a second polymer block having a second molecular weight in the second solvent;
forming a second complex by adsorbing block copolymer products having adsorbability to the second adsorbent; and
separating the second complex from the second solvent.

4. The method of claim 3, wherein the block copolymer comprises block copolymer products comprising a first block copolymer, a second block copolymer, and a third block copolymer,
wherein the first polymer block of the first block copolymer has a molecular weight equal to the first molecular weight,
wherein the first polymer block of the second block copolymer has a molecular weight greater than the first molecular weight, and
wherein the first polymer block of the third block copolymer has a molecular weight smaller than the first molecular weight.

5. The method of claim 4, wherein the second complex comprises the first block copolymer adsorbed on the second adsorbent, and
wherein the second block copolymer is not adsorbed on the second adsorbent.

6. The method of claim 3, wherein first homopolymer and second homopolymer impurities, formed by polymerizing the first monomer and second monomer to provide the block copolymer comprising block copolymer products, each have differing adsorbability to the first adsorbent and the second adsorbent.

7. The method of claim 6, wherein the first complex further comprises the first homopolymer adsorbed to the first adsorbent, and
wherein the second homopolymer is not adsorbed by the first adsorbent in the first solvent.

8. The method of claim 6, wherein the first homopolymer is not adsorbed by the second adsorbent in the second solvent.

9. The method of claim 3, wherein the second solvent comprises:
a main solvent in which a hydrophilic polymer has a high solubility, and in which the main solvent has a volume ratio of 50 vol % to 70 vol %; and
a co-solvent in which the hydrophilic polymer has a low solubility, and in which the co-solvent has a volume ratio of 30 vol % to 50 vol %.

10. The method of claim 1, wherein the first polymer block comprises a hydrophobic polymer, and
wherein the first adsorbent comprises silica particles coated with alkyl chains.

11. The method of claim 1, wherein the first solvent comprises:
a main solvent in which a hydrophobic polymer has a high solubility, and in which the main solvent has a volume ratio of 50 vol % to 70 vol %; and
a co-solvent in which the hydrophobic polymer has a low solubility, and in which the co-solvent has a volume ratio of 30 vol % to 50 vol %.

12. The method of claim 11, wherein the main solvent comprises methylene chloride, and
wherein the co-solvent comprises acetonitrile.

13. The method of claim 1, further comprising:
forming a first block copolymer composition by filtering and precipitating the first mixture solution from which the first complex is separated,
wherein the first block copolymer composition comprises a composition ratio of block copolymer products that is different from that of the block copolymer products of the block copolymer formed by polymerizing the first monomer and the second monomer.

14. The method of claim 1, further comprising:
adding the first complex into a solvent having high solubility to desorb the block copolymer products from the first adsorbent.

15. A method for purifying a block copolymer, the method comprising:
polymerizing a first monomer and a second monomer to form a block copolymer that comprises block copolymer products, the block copolymer products comprising a hydrophobic polymer block and a hydrophilic polymer block;
forming a first mixture solution by dissolving the block copolymer and a hydrophobic adsorbent in a first solvent;
forming a first complex by adsorbing block copolymer products onto the hydrophobic adsorbent, the hydrophobic adsorbent having adsorbability with respect to the hydrophobic polymer block having a first molecular weight or more in the first solvent; and
separating the first complex from the first solvent,
wherein the block copolymer products comprises a first block copolymer, a second block copolymer, and a third block copolymer,
wherein the hydrophobic polymer block of the first block copolymer has a molecular weight equal to the first molecular weight,
wherein the hydrophobic polymer block of the second block copolymer has a molecular weight greater than the first molecular weight, and
wherein the hydrophobic polymer block of the third block copolymer has a molecular weight smaller than the first molecular weight.

16. The method of claim 15, further comprising:
forming a second mixture solution by dissolving the block copolymer products that were adsorbed by the hydrophobic adsorbent to form the first complex and a hydrophilic adsorbent in a second solvent, the hydrophilic adsorbent having adsorbability with respect to block copolymer products comprising a hydrophilic polymer block in the second solvent;
forming a second complex by adsorbing block copolymer products having adsorbability to the hydrophilic adsorbent; and
separating the second complex from the second solvent.

17. The method of claim 16, wherein the second solvent comprises:
a main solvent in which a hydrophilic polymer has a high solubility, and in which the main solvent has a volume ratio of 50 vol % to 70 vol %; and
a co-solvent in which the hydrophilic polymer has a low solubility, and in which the co-solvent having a volume ratio of 30 vol % to 50 vol %.

18. The method of claim 16, wherein the hydrophobic adsorbent comprises silica particles coated with alkyl chains.

19. The method of claim 15, wherein the first solvent comprises:
a main solvent in which a hydrophobic polymer has a high solubility with respect to a polymer, and in which the main solvent has a volume ratio of 50 vol % to 70 vol %; and
a co-solvent in which the hydrophobic polymer has a low solubility, and in which the co-solvent having a volume ratio of 30 vol % to 50 vol %.

20. The method of claim 19, wherein the main solvent comprises methylene chloride, and
wherein the co-solvent comprises acetonitrile.
